(19) United States
(12) Patent Application Publication
(10) Pub. No.: US 2014/0169350 A1
(43) Pub. Date: Jun. 19, 2014

(54) APPARATUS AND METHOD FOR DETERMINING IDENTITY OF WIRELESS LAN SYSTEM

(71) Applicant: ELECTRONICS AND TELECOMMUNICATIONS REASEARCH INSTITUTE, Daejeon (KR)

(72) Inventors: Hoi Yoon JUNG, Daejeon (KR); Hyun Duk KANG, Gwangju (KR); Gwang Zeen KO, Daejeon (KR); Myung Sun SONG, Daejeon (KR); Jae Ick CHOI, Daejeon (KR)

(73) Assignee: Electronics and Telecommunications Reasearch Institute, Daejeon (KR)

(21) Appl. No.: 13/778,603

(22) Filed: Feb. 27, 2013

(30) Foreign Application Priority Data
Dec. 17, 2012 (KR) 10-2012-0147537

(51) Int. Cl. H04W 84/12

(52) U.S. Cl. CPC H04W 84/12
USPC 370/338

(57) ABSTRACT

Disclosed are an apparatus and a method for determining an identity of a WLAN system occupying a channel, using information within a signal field or time synchronization between target channels. For this, the present invention includes a preamble detecting unit configured to detect a preamble in each channel; a channel information obtaining unit configured to obtain reference time information when the preamble is detected in each channel, or to obtain signal field information in each channel using the detected preamble; and an identity determining unit configured to determine an identity of a WLAN system occupying each channel by comparing the reference time information obtained in each channel, or by comparing the signal field information obtained in each channel.

### CROSS-REFERENCE TO RELATED APPLICATIONS

This application claims priority to and the benefit of Korean Patent Application No. 10-2012-0147537 filed in the Korean Intellectual Property Office on Dec. 17, 2012, the entire contents of which are incorporated herein by reference.

### TECHNICAL FIELD

The present invention relates to an apparatus and a method for determining an identity of a wireless local area network (WLAN) system. More particularly, the present invention relates to an apparatus and a method for determining an identity of a WLAN system occupying a channel.

### BACKGROUND ART

A wireless local area network (WLAN) system according to a related art shares and thereby uses a wireless resource using a carrier sense multiple access with collision avoidance (CSMA/CA) method. The CSMA/CA method is an interference avoidance method that performs signal detection in advance with respect to whether a different system or signal is present within a corresponding channel before transmitting and receiving data using a wireless channel, and performs data transmission and reception when the corresponding channel is empty.

Here, a signal detection method for verifying whether a wireless channel is empty generally includes an energy detection method and a preamble detection method. The energy detection method determines only whether a signal is present within a channel by measuring only an energy level of the corresponding channel. The preamble detection method determines whether a WLAN system is present within the corresponding channel by performing signal detection with respect to a preamble of the WLAN system.

In the above methods according to the related art, when detecting the WLAN system, only information about whether the signal is present within the corresponding channel and continuance time information of the signal are obtained. Accordingly, when the WLAN system is detected in a plurality of channels, it is not possible to determine whether the plurality of channels is being used by an identical system or is being used by different systems.

U.S. Pat. No. 5,852,405 discloses a WLAN system. However, the above application invention may only determine whether a search target channel is being currently used, using a preamble and thus, does not solve the above issue.

### SUMMARY OF THE INVENTION

The present invention has been made in an effort to provide an apparatus and a method for determining an identity of a wireless local area network (WLAN) system that determines an identity of a WLAN system occupying a channel, using information within a signal (SIG) field or time synchronization between target channels.

However, the object of the present invention is not limited to the aforementioned matters and other objects not described above will be clearly understood by those skilled in the art from the following description.

An exemplary embodiment of the present invention provides an apparatus for determining an identity of a WLAN system, the apparatus including a preamble detecting unit configured to detect a preamble in each channel; a channel information obtaining unit configured to obtain reference time information when the preamble is detected in each channel, or to obtain signal (SIG) field information in each channel using the detected preamble; and an identity determining unit configured to determine an identity of a WLAN system occupying each channel by comparing the reference time information obtained in each channel, or by comparing the signal field information obtained in each channel.

The channel information obtaining unit obtains data length information or rate information of a signal field as the signal field information. The channel information obtaining unit obtains information associated with a modulation/demodulation order of a channel as the rate information.

The channel information obtaining unit obtains, as the reference time information, time information that is determined based on time synchronization between different channels. The channel information obtaining unit obtains, as the reference time information, time information of when a power value obtained when the preamble is detected is greater than or equal to a predetermined threshold.

The identity determining unit determines that an identical WLAN system is occupying corresponding channels when the reference time information or the signal field information is identical, and determines that different WLAN systems are occupying the respective channels when the reference time information or the signal field information is different.

The identity determining apparatus of the WLAN system further includes a channel occupancy determining unit configured to compare a power value obtained when the preamble is detected with a predetermined threshold, to determine that a corresponding channel is occupied when the power value is greater than or equal to the threshold value, and to determine that the corresponding channel is not occupied when the power value is less than the threshold.

The identity determining unit determines an identity of a high throughput (HT) WLAN system or a very high throughput (VHT) WLAN system.

Another exemplary embodiment of the present invention provides a method of determining an identity of a WLAN system, the method including a preamble detecting operation of detecting a preamble in each channel; a channel information obtaining operation of obtaining reference time information when the preamble is detected in each channel, or obtaining signal (SIG) field information in each channel using the detected preamble; and an identity determining operation of determining an identity of a WLAN system occupying each channel by comparing the reference time information obtained in each channel, or by comparing the signal field information obtained in each channel.

The channel information obtaining operation obtains data length information or rate information of a signal field as the signal field information. The channel information obtaining operation obtains information associated with a modulation/demodulation order of a channel as the rate information.

The channel information obtaining operation obtains, as the reference time information, time information that is determined based on time synchronization between different channels. The channel information obtaining operation obtains, as the reference time information, time information of when a power value obtained when the preamble is detected is greater than or equal to a predetermined threshold.

The identity determining operation determines that an identical WLAN system is occupying corresponding channels when the reference time information or the signal field information is identical, and determines that different WLAN systems are occupying the respective channels when the reference time information or the signal field information is different.

Between the preamble detecting operation and the channel information obtaining operation, the method of determining the identity of the WLAN system further includes, comparing a power value obtained when the preamble is detected with a predetermined threshold, determining that a corresponding channel is occupied when the power value is greater than or equal to the threshold value, and determining that the corresponding channel is not occupied when the power value is less than the threshold.

The identity determining operation determines an identity of an HT WLAN system or a VHT WLAN system.

According to exemplary embodiments of the present invention, it is possible to additionally obtain occupancy types of a plurality of channels in addition to information about whether a signal is present within a current channel of interest and a continuance time of the signal. The obtained information may be variously used for peripheral environment recognition and interference avoidance of a WLAN system, and the like. For example, in the case of a static bandwidth operation VHT system, and in the case of using two channels, compared to a case in which the two channels are occupied by different systems, it is possible to achieve further excellent sharing performance or efficiently use resources in a case in which the two channels are used by an identical system. In addition to the above example, by obtaining information about a WLAN system using a channel, that is, an interference source, it is possible to apply an interference control and avoidance method that is in a more intelligent and developed form.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically illustrating an apparatus for determining an identity of a wireless local area network (WLAN) system according to an exemplary embodiment of the present invention.

FIG. 2 is a conceptual diagram illustrating (a physical layer convergence procedure (PLCP)) protocol data unit (PPDU) type of a WLAN system.

FIG. 3 is a conceptual diagram illustrating information stored in a signal (SIG) field (L-SIG) of a WLAN system.

FIG. 4 is an exemplary diagram when a WLAN signal is detected.

FIG. 5 is an exemplary diagram when a WLAN signal is not detected.

FIG. 6 is an exemplary diagram about a CCA operation of a WLAN system using a plurality of channels.

FIG. 7 is an exemplary diagram when time synchronization detection results about a plurality of channels match.

FIG. 8 is an exemplary diagram when time synchronization detection results about a plurality of channels mismatch.

FIG. 9 is a flowchart illustrating a method of detecting a WLAN system according to an exemplary embodiment of the present invention.

FIG. 10 is a flowchart schematically illustrating a method of determining an identity of a WLAN system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. Initially, when assigning reference numerals with respect to constituent elements of each drawing, it should be noted that, if possible, like reference numerals refer to like constituent elements even though they are illustrated in different drawings. When it is determined that the detailed description related to a related known function or configuration may make the purpose of the present invention unnecessarily ambiguous in describing the present invention, the detailed description will be omitted here. Even though the exemplary embodiments of the present invention are hereinafter described, the technical spirit of the present invention is not limited thereto or restricted thereby and may be variously modified and thereby implemented by those skilled in the art.

The present invention proposes a method of obtaining additional information about a system currently occupying a channel by using additional information during a signal detection process of a wireless local area network (WLAN) system. During a WLAN signal detection process according to a related art, only information about whether a channel of interest is occupied and information about an occupancy time are obtained. In the proposed method, it is possible to obtain additional information about a system currently using a channel by applying whether signal (SIG) fields match and whether time synchronization matches with respect to a plurality of channels, and the like.

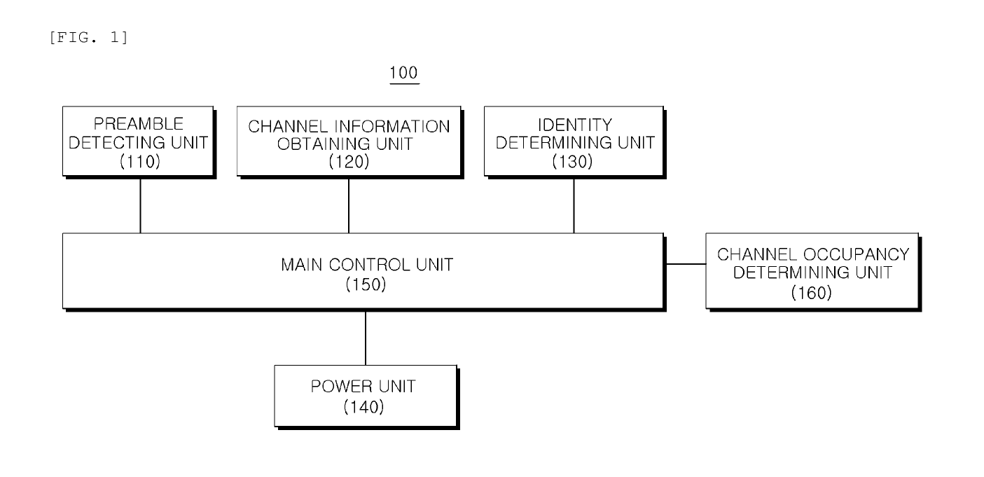

FIG. 1 is a block diagram schematically illustrating an apparatus for determining an identity of a WLAN system according to an exemplary embodiment of the present invention. Referring to FIG. 1, an identity determining apparatus 100 of the WLAN system includes a preamble detecting unit 110, a channel information obtaining unit 120, an identity determining unit 130, a power unit 140, and a main control unit 150. In addition thereto, the identity determining apparatus 100 of the WLAN system may further include a channel occupancy determining unit 160.

The identity determining apparatus 100 of the WLAN system may be mounted to a user terminal of which an access point (AP) or a channel occupancy state is to be verified.

The preamble detecting unit 110 functions to detect a preamble in each channel.

The channel information obtaining unit 120 functions to obtain reference time information when the preamble is detected in each channel, or to obtain signal (SIG) field information in each channel using the detected preamble.

The channel information obtaining unit 120 may obtain, as the reference time information, time information that is determined based on time synchronization between different channels. Here, the channel information obtaining unit 120 may obtain, as the reference time information, time information of when a power value obtained when the preamble is detected is greater than or equal to a predetermined threshold.

The channel information obtaining unit 120 may obtain data length information or rate information of a signal field as the signal field information. Here, the channel information obtaining unit 120 may obtain information associated with a modulation/demodulation order of a channel as the rate information.

The identity determining unit 130 functions to determine an identity of a WLAN system occupying each channel by comparing the reference time information obtained in each channel, or by comparing the signal field information obtained in each channel.

The identity determining unit 130 determines that an identical WLAN system is occupying corresponding channels when the reference time information or the signal field information is identical, and determines that different WLAN systems are occupying the respective channels when the reference time information or the signal field information is different. That is, in the case of obtaining data length information or rate information of the signal field as the signal field information, the identity determining unit 130 determines that the identical WLAN system is occupying the corresponding channels when the data length information or the rate information is identical, and determines that different WLAN systems are occupying the respective channels when the data length information or the rate information is different. In the case of obtaining time synchronization information as the reference time information, the identity determining unit 130 determines that the identical WLAN system is occupying the corresponding channels when the time synchronization matches, and determines that different WLAN systems are occupying the respective channels when the time synchronization mismatches.

The identity determining unit 130 determines an identity of a high throughput (HT) WLAN system or a very high throughput (VHT) WLAN system among the WLAN systems.

The power unit 140 functions to supply power to each configuration that constitutes the identity determining apparatus 100 of the WLAN system.

The main control unit 150 functions to control the overall operation of each configuration that constitutes the identity determining apparatus 100 of the WLAN system.

The channel occupancy determining unit 160 functions to compare a power value obtained when the preamble is detected with a predetermined threshold. The channel occupancy determining unit 160 determines that a corresponding channel is occupied when the power value is greater than or equal to the threshold value, and determines that the corresponding channel is not occupied when the power value is less than the threshold.

The object of the present invention is to detect and identify an interference system within a band by using signal detection in the WLAN system. A signal detection method in which a WLAN system verifies whether a wireless channel is empty according to a related art includes an energy detection method and a preamble detection method. The present invention corresponds to a WLAN system detection method through preamble detection of the WLAN system.

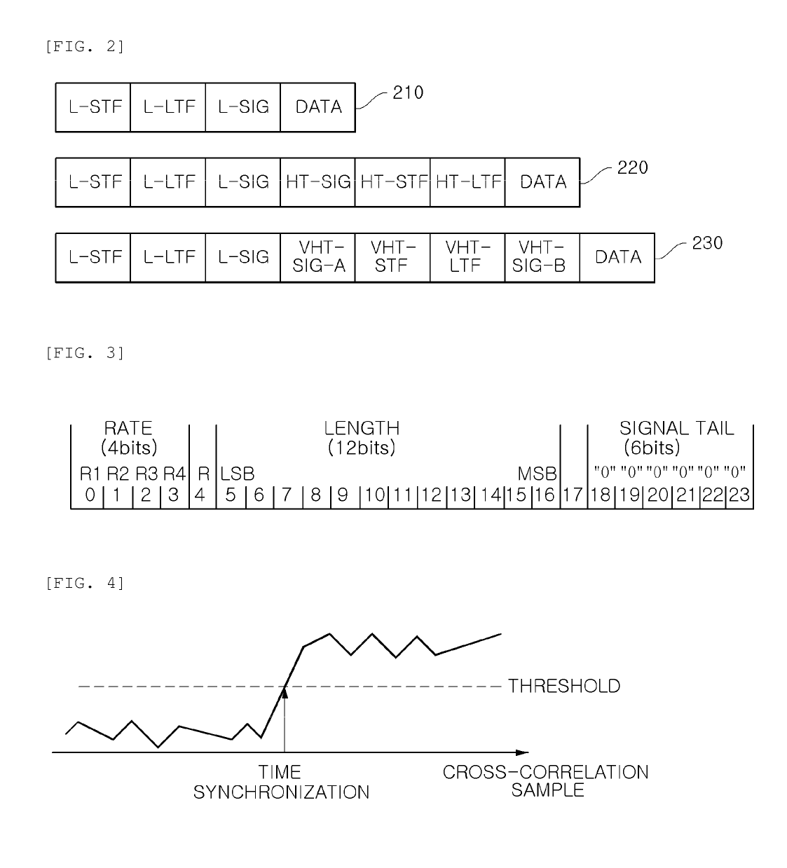

FIG. 2 is a conceptual diagram illustrating (a physical layer convergence procedure (PLCP)) protocol data unit (PPDU) type of a WLAN system. FIG. 3 is a conceptual diagram illustrating information stored in a signal (SIG) field (L-SIG) of the WLAN system.

As illustrated in FIG. 2, there are three representative types 210, 220, and 230 for the PPDU type of the WLAN system. In the above, the PLCP indicates a physical layer convergence procedure.

The type 210 indicates a PPDU type of a legacy mode. A non-HT short training field (L-STF) is a preamble having a pattern repeated in a time domain and is generally used to match time synchronization. A non-HT long training field (L-LTF) is a preamble similar to the L-STF but having a short repetition period, and is generally used to estimate a channel. A non-HT signal field (L-SIG) includes information about a modulation/demodulation rate about data and data length.

FIG. 3 illustrates a configuration of an SIG field. Rate information for expressing a modulation/demodulation order is expressed using four bits, length information for expressing data length is expressed using 12 bits, and remaining information is a reserved bit or a tail bit set to “zero”.

The type 220 indicates a mixed HT PPDU type. A mixed HT mode is a mode used to support both an HT device and a non-HT device in a circumstance in which the HT device and the non-HT device co-exist. In the mixed HT mode, the L-STF, the L-LTF, and the L-SIG are identical to the legacy mode and thus, may also be interpreted by a device of the legacy mode. Information after an HT-SIG may be interpreted only by a device of an HT mode.

The type 230 indicates a VHT PPDU type, which is similar to the mixed HT PPDU type, but has difference in that information after VHT-SIG-A may be interpreted only by a device of a VHT mode.

When performing signal detection with respect to the PPDU type of the WLAN system, presence itself of a WLAN signal may be detected by performing cross-correlation with respect to a repetitive pattern of the L-STF. However, when there is information about by when a signal currently using a channel may use the channel, other devices may have no need to determine whether the channel is empty or being used during a corresponding time. As described above, the L-SIG includes information about a modulation/demodulation order of a corresponding signal and data length. Accordingly, when using the above information, it is possible to obtain information about how long the corresponding signal may occupy a channel. When other device is possible to know a continuance time of the signal currently occupying the channel, it is possible to reduce power consumption of the device by determining that the channel is occupied by the signal during the corresponding time and by suspending an energy detection and preamble detection activity for determining whether the channel is occupied. This is referred to as a network allocation vector (NAV) in the WLAN system.

In a signal detection process of the WLAN system, all the detection of the WLAN system is performed by using cross-correlation with respect to a preamble signal. A cross-correlation operation with a preamble pattern, defined in a standard and the like, may be performed with respect to a received signal. Here, when the received signal is a signal of the WLAN system, a cross-correlation operation value with the preamble pattern has a peak value beyond a predetermined threshold. When the received signal is not the signal of the WLAN system, a peak is not detected. As described above, whether the WLAN system is present is determined based on whether the cross-correlation operation value exceeds the threshold.

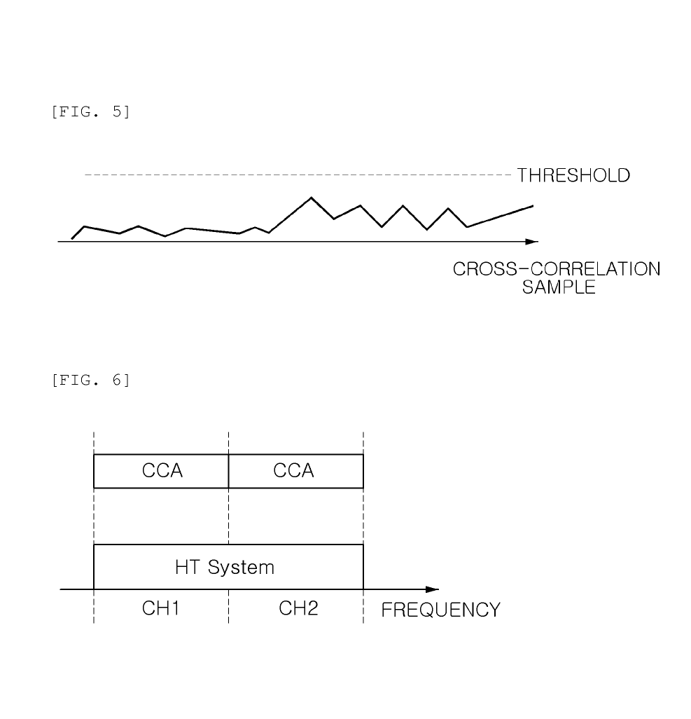

FIG. 4 is an exemplary diagram when a WLAN signal is detected. FIG. 5 is an exemplary diagram when the WLAN signal is not detected.

FIG. 4 illustrates a detection example of the WLAN signal when using a WLAN signal detection method, and FIG. 5 illustrates a non-detection example of the WLAN signal. As illustrated in FIG. 4, with respect to the WLAN signal, cross-correlation between a received signal and a preamble pattern indicates a peak value greater than or equal to a threshold. A point at which a cross-correlation sample exceeds the threshold, or a point at which the predetermined number of cross-correlation samples continuously exceed the threshold is used as a time synchronization point of the WLAN system. FIG. 5 illustrates an example of a cross-correlation value when the WLAN signal is not detected in the received signal.

Meanwhile, when the WLAN signal is detected in the received signal as illustrated in FIG. 4, time synchronization is matched by generally using the L-STF based on the PPDU type of FIG. 2, and a channel is estimated using the L-LTF. When the above process is terminated, demodulation may be performed with respect to PPDU after the L-LTF. Meanwhile, as described above, the L-SIG field includes information about a modulation/demodulation order of a corresponding signal and data length and thus, it is possible to estimate a channel occupancy time of the corresponding signal based on the information.

A technical subject of the present invention is to obtain additional information about a system currently using a channel applying a signal detection method of a WLAN system, in addition to simple information about whether the channel is currently occupied and an occupancy continuance time.

The present invention proposes a WLAN system detection method that obtains additional information about a WLAN system currently using a channel, by applying additional information during a WLAN signal detection process. For ease of description of the present invention, a description will be made based on the assumption that an application example of the present invention is a system for supporting HT or VHT.

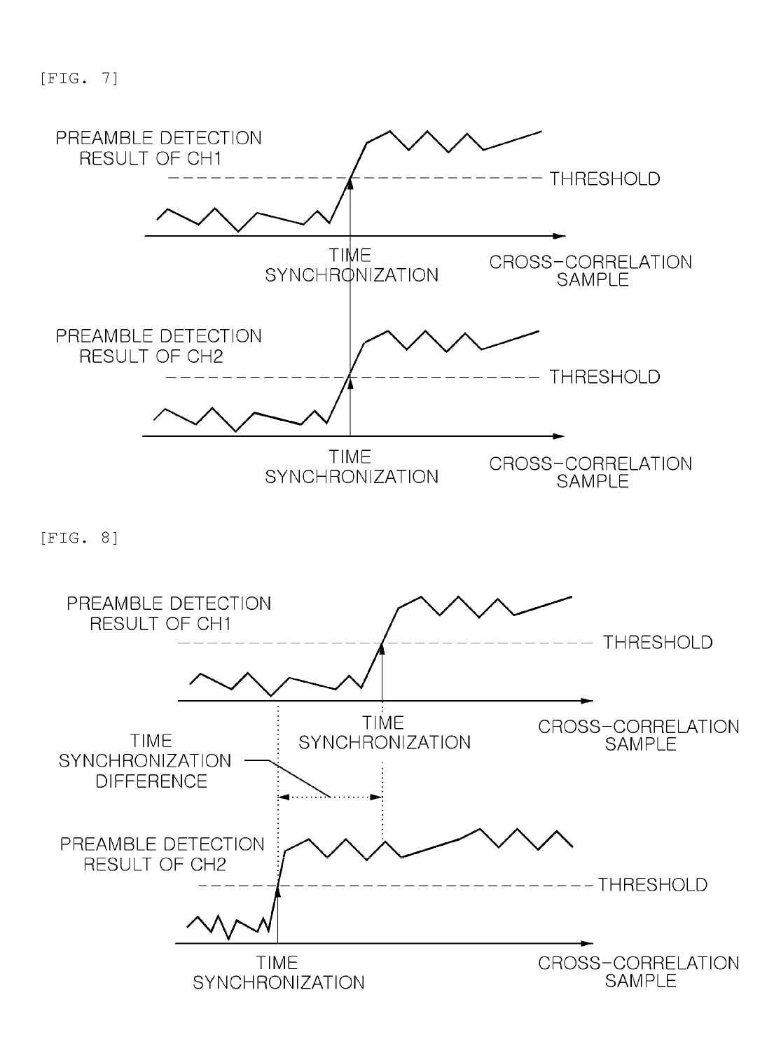

An HT system or a VHT system uses a wider band, which is different from an existing legacy mode device. For example, a legacy system uses a bandwidth of 20 MHz, whereas the HT system supports a bandwidth of 20 MHz or 40 MHz and the VHT system supports a bandwidth of 20 MHz, 40 MHz, 80 MHz, or 160 MHz. Here, an example of a CCA process when the HT system or the VHT system uses a broadband or a multiband is illustrated in FIG. 6. FIG. 6 illustrates an exemplary diagram about a CCA operation of a WLAN system using a plurality of channels.

As illustrated in FIG. 6, the HT system using two channels, Ch1 and Ch2, transmits data by simultaneously using Ch1 and Ch2 and thus, performs all of CCAs with respect to Ch1 and Ch2. Here, when all of Ch1 and Ch2 are empty, the HT system performs data transmission and reception using Ch1 and Ch2. When a WLAN signal is detected in Ch1 and Ch2, the HT system detects a preamble and obtains SIG field information and then stands by using the obtained information without performing a CCA during a signal continuance time.

When the WLAN signal is detected in all of Ch1 and Ch2 as a result of performing the CCA, it is not possible to determine whether Ch1 and Ch2 are being used by an identical system or are being used by different systems in the related art. Hereinafter, a variety of methods for detecting this are proposed.

The first method is a method using information within a SIG field. According to a standard of the WLAN system, a single system uses an identical modulation/demodulation order within all of the bands. Accordingly, when modulation/demodulation orders (rates) of two channels are different by detecting a preamble and then obtaining SIG field information with respect to each of Ch1 and Ch2, it is possible to determine that Ch1 and Ch2 are being used by different systems. When Ch1 and Ch2 are being used by an identical system, lengths of data to be transmitted also need to be identical regardless of channels. Accordingly, when two channels have different data length information of the SIG field, it is possible to determine that the respective channels are being used by different systems.

The second method is a method using time synchronization of two channels. In an operation circumstance of FIG. 6, a system performs preamble detection with respect to Ch1 and Ch2. When a WLAN signal is present within a channel, the result of FIG. 4 is obtained. When the WLAN signal is absent, the result of FIG. 5 is obtained. Meanwhile, here, when the WLAN signal is present within all of Ch1 and Ch2, all of the preamble detection results with respect to Ch1 and Ch2 may be similar to FIG. 4, but a point in time of time synchronization may vary.

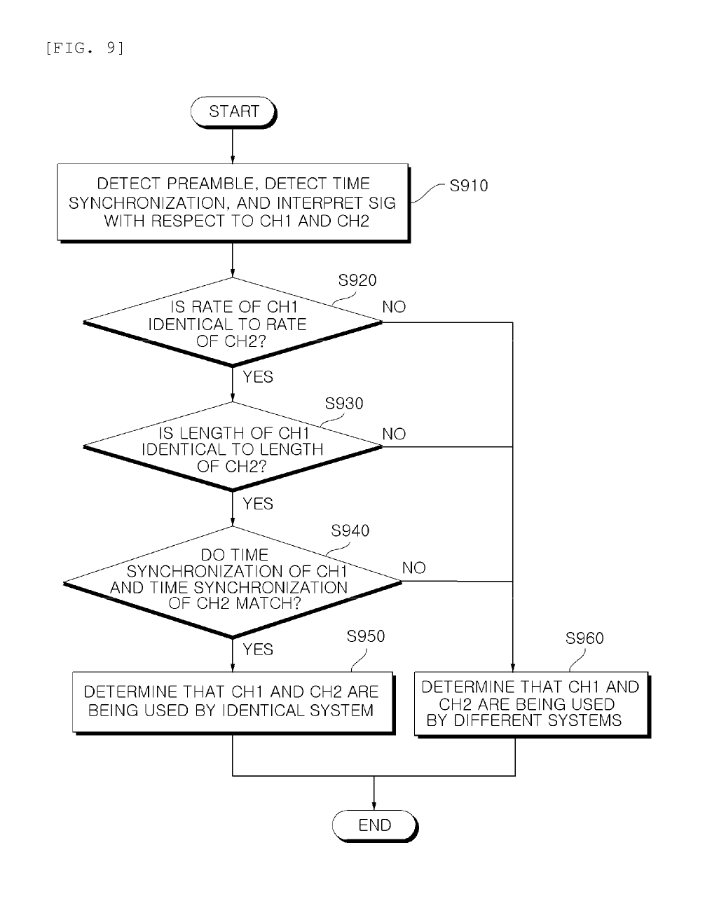

FIG. 7 is an exemplary diagram when time synchronization detection results about a plurality of channels match. FIG. 8 is an exemplary diagram when time synchronization detection results about a plurality of channels mismatch.

An example of preamble detection and time synchronization detection in Ch1 and Ch2 is illustrated in FIG. 7. As it can be seen from the example of FIG. 7, time synchronizations of a received signal were detected at an identical or similar time based on a cross-correlation sample in Ch1 and Ch2. Accordingly, in this case, it is possible to assume that Ch1 and Ch2 are being used by the identical system. Meanwhile, in FIG. 8, as the preamble and time synchronization detection results with respect to Ch1 and Ch2, time synchronizations were detected at different times. In this case, it indicates that systems using Ch1 and Ch2 are not synchronized with each other. Accordingly, it is possible to determine that the system using Ch1 and the system using Ch2 are different systems. Meanwhile, here, whether the time synchronization of Ch1 and time synchronization of Ch2 match may be determined by setting a predetermined threshold with respect to time synchronization difference. When the time synchronization difference is greater than the threshold, the systems using Ch1 and Ch2 may be determined as different systems. When the time synchronization difference is less than or equal to the threshold, the systems using Ch1 and Ch2 may be determined as the identical system.

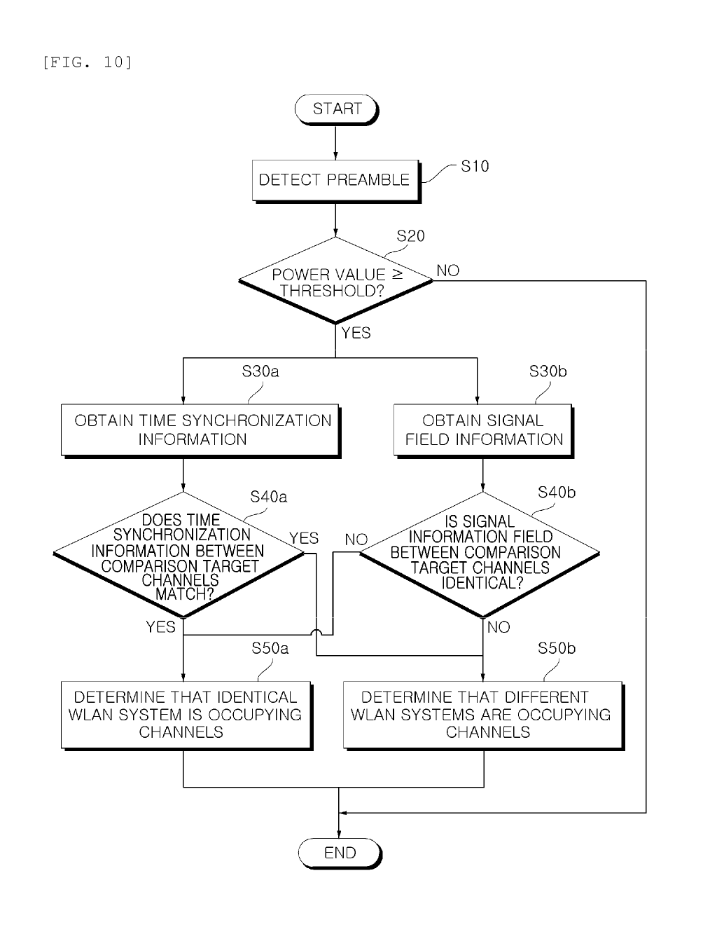

FIG. 9 is a flowchart illustrating a method of detecting a WLAN system according to an exemplary embodiment of the present invention. FIG. 9 illustrates contents proposed by the present invention as an exemplary flowchart.

In operation S910, preamble detection is performed with respect to two channels, Ch1 and Ch2, time synchronization according thereto is detected and then, an SIG field is interpreted.

In operation S920, whether a rate of an SIG field of Ch1 is identical to a rate of an SIG field of Ch2 is determined based on the above results about Ch1 and Ch2.

When the rate of SIG field of Ch1 is different from the rate of the SIG field of Ch2, operation S960 is performed and it is determined that Ch1 and Ch2 are being used by different systems, and the system detection is terminated.

When the rate of the SIG field of Ch1 is identical to the rate of the SIG field of Ch2, operation S930 is performed. In operation S930, length information of the SIG field of Ch1 is compared with length information of the SIG field of Ch2.

When the length information of the SIG field of Ch1 is different from the length information of the SIG field of Ch2, operation S960 is performed and it is determined that Ch1 and Ch2 are being used by different systems, and the system detection is terminated.

When the length information of the SIG field of Ch1 is identical to the length information of the SIG field of Ch2, operation S940 is performed. In operation S940, time synchronization information of Ch1 is compared with time synchronization information of Ch2 based on time synchronization information using preamble detection. When time synchronization information between two channels is different, operation S960 is performed and it is determined that Ch1 and Ch2 are occupied by different systems, and the system detection is terminated. On the other hand, when the time synchronization information of Ch1 matches the time synchronization of Ch2, operation S950 is performed and it is determined that Ch1 and Ch2 are being used by an identical system and the system detection is terminated.

The method according to the flowchart of FIG. 9 is only an example and thus, the present invention is not limited thereto. Orders of operations S920 to S940 maybe changed based on configuration and application of the present invention and thereby be applied and configured. Deletion or addition of a portion of operations falls within the scope of the present invention. Meanwhile, FIG. 9 illustrates only contents about detection of a current channel occupancy state of the WLAN system and may be combined with a predetermined CCA process such as energy detection, preamble detection, and the like, for WLAN signal detection according to the related art and thereby be used in various types. In association with determining whether time synchronization of Ch1 and time synchronization of Ch2 match, various time synchronization detection algorithms may be applied based on a configuration of a system. However, regardless of a method of a time synchronization detection algorithm, determination is made using only the result of the time synchronization detection algorithm and thus, universal application is enabled. Whether time synchronization of Ch1 and time synchronization of Ch2 match may be determined by setting a predetermined threshold with respect to time synchronization difference, and by determining whether the time synchronization difference exceeds the threshold. Here, the threshold may organically vary based on embodiments.

For ease of key description of the present invention, the description is made by assuming a circumstance in which the HT system and only two channels, Ch1 and Ch2, are present as illustrated in FIG. 6. However, the present invention may be applied even to a circumstance in which the VHT system and at least two channels are present. For example, in a circumstance in which four channels are present, the present invention may be applied to each of Ch1-Ch2, Ch2-Ch3, and Ch3-Ch4, with respect to four channels, Ch1, Ch2, Ch3, and Ch4. Accordingly, detection is enabled when four channels are used by different systems, respectively. Even in an environment in which Ch1 and Ch2 are being used by a predetermined system A and Ch3 and Ch4 are being used by a predetermined system B, detection is enabled. In a case in which Ch1 to Ch3 are being used by a single system and Ch4 is being used by another single system, and in a case in which all of four channels, Ch1 to Ch4, are being used by a single system, detection is also enabled. Meanwhile, in the case of applying the present invention to the aforementioned case in which at least two channels are present, the present invention may be configured to simultaneously apply the information comparison process such as operations S920 to S940 to at least two channels, instead of applying the information comparison process such as operations S920 to S940 only to two channels at a time.

Next, a method of determining an identity of a WLAN system using the identity determining apparatus 100 of FIG. 1 will be described. FIG. 10 is a flowchart schematically illustrating a method of determining an identity of a WLAN system according to an exemplary embodiment of the present invention.

Initially, the preamble detecting unit 110 detects a preamble in each channel (S10).

After operation S10, the channel information obtaining unit 120 obtains reference time information when the preamble is detected in each channel (S30a), or obtains signal field information in each channel using the detected preamble (S30b).

In operation S30a, the channel information obtaining unit 120 may obtain, as the reference time information, time information that is determined based on time synchronization between different channels. In particular, the channel information obtaining unit 120 may obtain, as the reference time information, time information of when a power value obtained when the preamble is detected is greater than or equal to a predetermined threshold.

In operation 30b, the channel information obtaining unit 120 may obtain data length information or rate information of a signal field as the signal field information. In particular, the channel information obtaining unit 120 may obtain information associated with a modulation/demodulation order of a channel as the rate information.

After operation S30a or operation S30b, the identity determining unit 130 determines an identity of a WLAN system occupying each channel (S50a or S50b) by comparing the reference time information obtained in each channel (S40a), or by comparing the signal field information obtained in each channel (S40b).

The identity determining unit 130 determines that an identical WLAN system is occupying corresponding channels when the reference time information or the signal field information is identical, and determines that different WLAN systems are occupying the respective channels when the reference time information or the signal field information is different. That is, in the case of obtaining time synchronization as reference time information, the identity determining unit 130 determines that the identical WLAN system is occupying the corresponding channels (S50a) when the reference time information or the signal field information is identical (S40a), and determines that the different WLAN systems are occupying the respective channels (S50b) when the reference time information or the signal field information is different (S40b). In the case of obtaining data length information or rate information of the signal field as the signal field information, the identity determining unit 130 determines that the identical WLAN system is occupying the corresponding channels (S50a) when the data length information or the rate information is identical (S40a), and determines that the different WLAN systems are occupying the respective channels (S50b) when the data length information or the rate information is different (S40b).

Meanwhile, between operation S10 and operation S30a/S30b, the channel occupancy determining unit 160 compares a power value obtained when the preamble is detected with a predetermined threshold (S20). When the power value is greater than or equal to the threshold value, the channel occupancy determining unit 160 determines that a corresponding channel is occupied and continuously performs operations S30a or S30b. On the other hand, when the power value is less than the threshold, the channel occupancy determining unit 160 determines that the corresponding channel is not occupied and terminates system detection.

Even though all of the constituent elements constituting the aforementioned exemplary embodiments of the present invention are described to be combined into one or to operate through combination therebetween, the present invention is not limited to the exemplary embodiments. That is, without departing from the scope of the present invention, all of the constituent elements may be selectively combined into at least one and thereby operate. Even though each of all of the constituent elements may be configured as single independent hardware, a portion of or all of the constituent elements may be selectively combined and thereby configured as a computer program having a program module to perform a portion of or all of the functions combined in single or a plurality of items of hardware. The computer program may be stored in computer-readable media such as a universal serial bus (USB) memory, a CD disk, a flash memory, and the like, and thereby be read and executed by a computer, thereby embodying the exemplary embodiments of the present invention. The computer-readable media of the computer program may include magnetic storage media, optical storage media, carrier wave media, and the like.

Unless differently defined in the detailed description, terminology including technical or scientific terminology has a meaning identical to a meaning generally understood by those skilled in the art. Generally used terminology such as terminology defined in a dictionary needs to be interpreted to match a contextual meaning of the related art and thus, is not interpreted as an idealistically or excessively formal meaning unless clearly defined in the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for determining an identity of a wireless local area network (WLAN) system, the apparatus comprising:
a preamble detecting unit configured to detect a preamble in each channel;
a channel information obtaining unit configured to obtain reference time information when the preamble is detected in each channel, or to obtain signal (SIG) field information in each channel using the detected preamble; and
an identity determining unit configured to determine an identity of a WLAN system occupying each channel by comparing the reference time information obtained in each channel, or by comparing the signal field information obtained in each channel.

2. The apparatus of claim 1, wherein the channel information obtaining unit obtains data length information or rate information of a signal field as the signal field information.

3. The apparatus of claim 2, wherein the channel information obtaining unit obtains information associated with a modulation/demodulation order of a channel as the rate information.

4. The apparatus of claim 1, wherein the channel information obtaining unit obtains, as the reference time information, time information that is determined based on time synchronization between different channels.

5. The apparatus of claim 4, wherein the channel information obtaining unit obtains, as the reference time information, time information of when a power value obtained when the preamble is detected is greater than or equal to a predetermined threshold.

6. The apparatus of claim 1, wherein the identity determining unit determines that an identical WLAN system is occupying corresponding channels when the reference time information or the signal field information is identical, and determines that different WLAN systems are occupying the respective channels when the reference time information or the signal field information is different.

7. The apparatus of claim 1, further comprising:
a channel occupancy determining unit configured to compare a power value obtained when the preamble is detected with a predetermined threshold, to determine that a corresponding channel is occupied when the power value is greater than or equal to the threshold value, and to determine that the corresponding channel is not occupied when the power value is less than the threshold.

8. The apparatus of claim 1, wherein the identity determining unit determines an identity of a high throughput (HT) WLAN system or a very high throughput (VHT) WLAN system.

9. A method of determining an identity of a WLAN system, the method comprising:
a preamble detecting operation of detecting a preamble in each channel;
a channel information obtaining operation of obtaining reference time information when the preamble is detected in each channel, or obtaining signal (SIG) field information in each channel using the detected preamble; and
an identity determining operation of determining an identity of a WLAN system occupying each channel by comparing the reference time information obtained in each channel, or by comparing the signal field information obtained in each channel.

10. The method of claim 9, wherein the channel information obtaining operation obtains data length information or rate information of a signal field as the signal field information.

11. The method of claim 10, wherein the channel information obtaining operation obtains information associated with a modulation/demodulation order of a channel as the rate information.

12. The method of claim 9, wherein the channel information obtaining operation obtains, as the reference time information, time information that is determined based on time synchronization between different channels.

13. The method of claim 12, wherein the channel information obtaining operation obtains, as the reference time information, time information of when a power value obtained when the preamble is detected is greater than or equal to a predetermined threshold.

14. The method of claim 9, wherein the identity determining operation determines that an identical WLAN system is occupying corresponding channels when the reference time information or the signal field information is identical, and determines that different WLAN systems are occupying the respective channels when the reference time information or the signal field information is different.
